(19) United States
(12) Patent Application Publication
(10) Pub. No.: US 2008/0127452 A1
(43) Pub. Date: Jun. 5, 2008

(54) Floor hinge assembly

(76) Inventor: B. Stewart Jackson, Spartanburg, SC (US)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6731, US

(21) Appl. No.: 11/607,309

(22) Filed: Dec. 1, 2006

(51) Int. Cl. E05F 3/20

(52) U.S. Cl. 16/50

(57) ABSTRACT

An improved self returning floor mounted hinge assembly for a door. The hinge assembly includes a guide plate affixed to a support frame and having an opening substantially surrounding a linearly displaceable guide shaft. The opening in the guide plate is substantially aligned with an opening in the frame structure supporting the end of the guide shaft.

### TECHNICAL FIELD

This invention relates to a self-returning hinge assembly mounted between a support floor and a door. More particularly, the invention relates to a self-returning hinge assembly mounted between a support floor and a door utilizing a spring disposed along a linearly displaceable guide shaft element mounted through a supporting guide plate element. Upon displacement of the door from a pre-established set point, the spring is compressed by a compression element carried by the guide shaft element thereby generating a biasing force along the guide shaft to bring the door back to the pre-established set point. The linear travel path of the guide shaft element is maintained by the guide plate. A construction method for the hinge assembly is also provided.

### BACKGROUND OF THE INVENTION

Floor hinges are well known. As will be appreciated by those of skill in the art, such hinges typically use a base plate assembly that is bolted or otherwise mounted to the floor so as to remain substantially static. Such hinges also typically include a displaceable frame structure mounted to the door and operatively connected to the base plate assembly. Thus, when the door is moved, there is a relative movement between the frame structure and the base plate assembly.

Self returning floor hinges using a spring biased return are also well known. One exemplary spring biased floor hinge is the Model 7811 spring pivot marketed by Bommer Industries, Inc. having a place of business in Landrum, S.C. Such spring biased floor hinges incorporate a spring disposed along a linearly displaceable guide shaft element mounted within the displaceable frame structure. Upon displacement of the door from a pre-established set point, a cam follower attached to the guide shaft is displaced thereby moving the guide shaft in a linear manner and compressing the spring. The spring compression generates a biasing force along the guide shaft to bring the door back to the pre-established set point. In such prior floor hinges, the linear travel of the guide shaft is maintained by pin elements extending transverse to the guide shaft and projecting through guide slots in plates above and below the guide shaft. By constraining the pins within the guide slots, the operatively connected guide shaft is thereby limited to substantially linear travel in line with the guide slots as the cam follower is displaced.

While the prior construction self returning floor hinges have performed quite well, the prior design is nonetheless reliant upon the integrity of the pin elements and the guide slots to maintain consistent repeatable linear travel. Due to the large number of use cycles that these parts experience, it has been found to be desirable to use pins of substantial cross-sectional dimension connected to a relatively heavy cam follower body. Both the pins and the cam follower body are typically formed from hardened steel or the like. Moreover, it has been found that over extended periods of time, the guide slots may tend to experience a degree of wear that varies over the length of the slots. This variable wear is believed to result from the fact that the pins are subject to increasing forces as each individual cycle progresses such that the force between the pins and the edges of the guide slots is greatest when the guide shaft has been fully extended and the spring is compressed. This variable wear may give rise to a noticeable clicking sound over the life of the product.

### SUMMARY OF THE INVENTION

The present invention provides advantages and alternatives over the prior art by providing a self-returning hinge assembly mounted between a support floor and a door utilizing a spring disposed along a linearly displaceable guide shaft element mounted through a guide plate aperture. Upon displacement of the door from a pre-established set point, the spring is compressed by a compression element carried by the guide shaft element thereby generating a biasing force along the guide shaft to bring the door back to the pre-established set point. The linear travel path of the guide shaft element is maintained by the guide plate without the need for the prior pin and guide slot engagement. Substantial reductions in material weight and machining requirements may thus be realized while simultaneously reducing the potential for failure due to interactive wear between the components.

It is to be understood that other aspects, advantages, and features of the invention will become apparent through a reading of the following detailed description of the invention and/or through use of the invention. Accordingly, such description is to be understood to be exemplary and explanatory only and in no event is the invention to be limited to any illustrated and described embodiments. On the contrary, it is intended that the present invention shall extend to all alternatives and modifications as may embrace the principals of this invention within the true spirit and scope thereof.

### BRIEF DESCRIPTION OF THE DRAWINGS

The present invention will now be described by way of example only, with reference to the accompanying drawings which are incorporated in and which constitute a part of this specification herein and together with the general description of the invention given above, and the detailed description set forth below, serve to explain the principles of the invention wherein:

FIG. 1 is an exploded view of a potentially preferred exemplary self-returning floor hinge assembly;

FIG. 2 is an assembled view of the hinge assembly in FIG. 1 in attached relation to a door shown in phantom; and

FIG. 3 is a view taken along line 3-3 in FIG. 2, illustrating a range of motion and hold-open ability of the hinge assembly.

### DETAILED DESCRIPTION

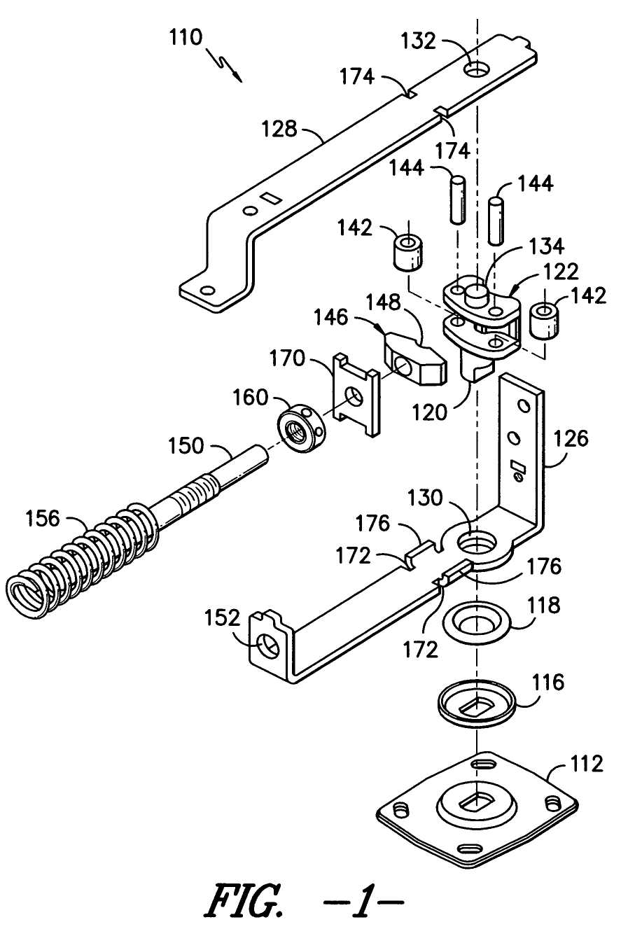

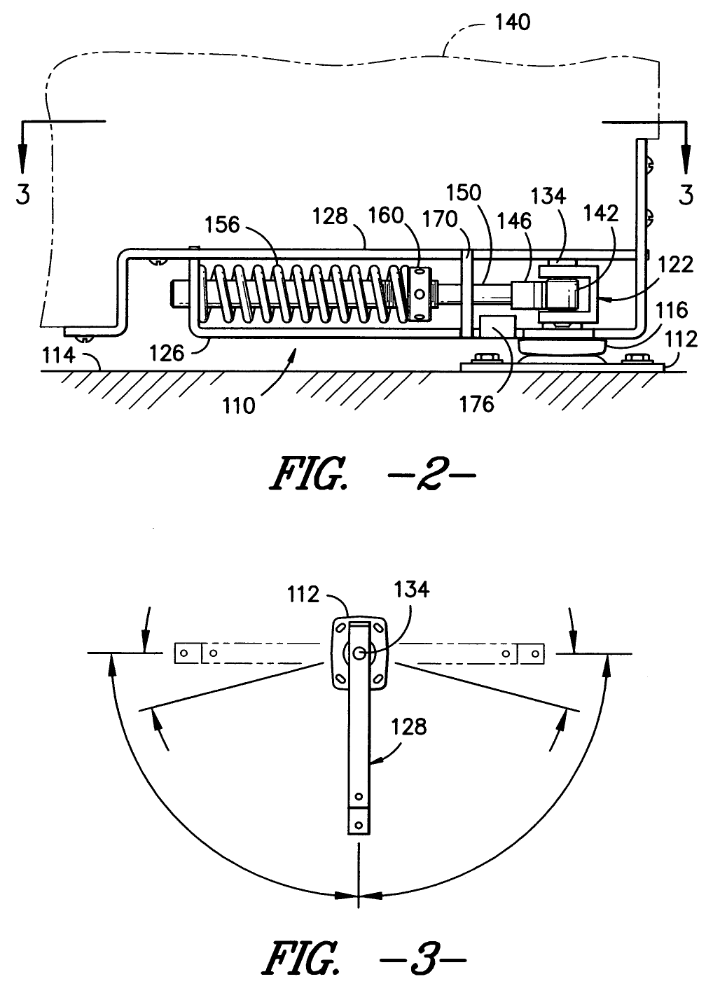

Reference will now be made to the drawings wherein, to the extent possible, like reference numerals are utilized to designate corresponding components throughout the various views. Looking now simultaneously to FIGS. 1 and 2, an exemplary hinge assembly 110 is illustrated. As shown, the hinge assembly 110 utilizes a base plate 112 mounted in substantially fixed relation to the floor 114 or other support surface. A bearing race 116 is secured to the base plate 112 and houses a bearing 118 such as a nylon ring bearing or the like. As shown, the base plate 112 and the bearing race include aligned key openings configured to accept a reduced diameter portion of a key post 120 projecting downwardly from a bearing cam assembly 122 as will be described further hereinafter. Thus, when the reduced diameter portion of a key post 120 projects through the aligned key openings, the bearing cam assembly 122 is held in fixed relation relative to the base plate 112.

In the illustrated construction the hinge assembly 110 includes a frame structure formed from a first or lower bracket 126 and a second or upper bracket 128. As shown, the first bracket 126 includes an opening 130 sized to accept the large diameter portion of the key post 120 without obstruction. The second bracket 128 likewise includes an opening 132 sized to accept a nipple 134 projecting upwardly from the bearing cam assembly 122. When the bearing cam assembly 122 is fixed in position relative to the base plate 112, the first and second brackets may rotate around the bearing cam assembly with an axis of rotation running through the nipple 134 and key post 120. As will be appreciated, the first and second brackets 126, 128 are preferably mounted in substantially fixed relation at a lower inner corner of a door 140 by screws, bolts or other appropriate fixation devices. Thus, as the door 140 is rotated, the first and second brackets 126, 128 move in concert with the door 140 while the bearing cam assembly 122 remains stationary held in place by the base plate 112.

As shown, the bearing cam assembly 122 preferably includes a pair of low friction rollers 142 of nylon or other polymeric material incorporating a wear activated lubricant such as graphite, molybdenum oxides, or the like as will be known to those of skill in the art. The rollers 142 are held in place by pins 144 on opposite sides of the axis defined by the nipple 134 and key post 120 such that they are substantially free to rotate. In the assembled state, the rollers 142 engage a cam follower thrust lug 146 which is preferably formed from the same material as the rollers so as to minimize friction. According to one potentially preferred construction, the thrust lug 146 incorporates a centrally disposed scalloped face depression 148.

In the illustrated and potentially preferred construction the thrust lug 146 is affixed at one end of a guide shaft 150 of carburized steel or like structural material. As best seen in FIG. 2, the end of the guide shaft 150 opposing the thrust lug 146 is preferably held within an opening 152 in an upwardly extending leg portion of the first bracket 126. A coil spring 156 is disposed in surrounding relation to the guide shaft 150 such that the guide shaft slides freely within the coil spring. In the assembled state the coil spring 156 is held between an adjustable collar 160 and the upwardly extending leg portion of the first bracket 126. As shown, the collar is carried on a threaded portion of the guide shaft 150. Thus, tensioning adjustments may be made by simply changing the position of collar 160 along the threaded portion of the guide shaft 150. Once the tensioning set point is fixed, axial stroke movement of the guide shaft through the spring and the opening 152 further compresses the spring 156 and generates a return biasing force as the spring seeks to relieve the increased applied compression.

As noted previously, in the potentially preferred construction the linear travel path of the guide shaft 150 is maintained by a guide plate 170 of hardened steel or like material disposed in surrounding relation to a portion of the guide shaft between the thrust lug 146 and the threads holding the tensioning collar 160. The travel opening within the guide plate 170 is preferably sized so as to permit the guide shaft to slide freely through the opening while maintaining a close fitted relation thereby holding the shaft substantially straight during axial movement. In the illustrated and potentially preferred construction the guide plate 170 is an “H” plate having a pair of lower posts fitted within acceptance slots 172 in opposing lateral edges of the lower bracket 126 and a pair of upper posts fitted within acceptance slots 174 in opposing lateral edges of the upper bracket 126 such that the guide plate 170 is held in substantially perpendicular relation to both the upper and lower brackets. One or both supporting brackets may include thickened or raised ear portions 176 adjacent to the lateral edge acceptance slots to provide added support.

Referring simultaneously to FIGS. 2 and 3, operation of the hinge in the assembled state will now be described. As previously noted, the bearing cam assembly 122 is held in fixed relation by its connection to the base plate 112 while the frame structure with attached guide shaft 150, thrust lug 146, spring 156 and guide plate 170 move with the door 140. Accordingly, as the door 140 is moved away from its starting position shown in FIG. 2, the thrust lug 146 rides over the surface of the rollers 142. As surfaces of the thrust lug outboard of the face depression 148 ride over a contacting roller 142, the thrust lug and attached guide shaft 150 are progressively pushed away from the bearing cam assembly 122 due to angle of the thrust lug face. That is, as the thrust lug 148 rotates around a roller 142, the point of contact between the thrust lug and the roller moves from a low profile outboard portion of the thrust lug face towards higher profile interior positions. This translates to axial movement of attached guide shaft 150 in a path defined by the axis running between the opening in the guide plate 170 and opening 152 in the upwardly extending leg portion of the first bracket 126. The axial movement away from the bearing cam assembly in turn causes compression of the spring 156 due to pressure from the collar 160.

In the illustrated construction incorporating a face depression 148 at a central portion of the thrust lug 146 continued rotation eventually causes the point of contact between the thrust lug and the roller 142 to move into the zone occupied by the face depression 148 such that the roller drops into the depression. With the roller 142 disposed within the face depression 148, the door 140 will remain ajar until a return rotational force is applied by an operator forcing the roller back onto the sloped face. Thus, as best seen in FIG. 3, the illustrated construction permits the door to be moved through a substantial angle with self biasing return over the interior portion of the angle and with the ability to hold the door open at the angle extremes. Of course, the use of a face depression on the thrust lug is optional. By way of example only, in the event that a face depression is not utilized, the thrust lug may simply use a face which tapers to an apex at the center. As will be appreciated, in such a construction the hinge will be self returning over substantially its full range of motion.

Regardless of the thrust lug construction which may be utilized, it has been found that the utilization of a guide plate 170 supporting the guide shaft 150 in aligned relation with a frame opening provides adequate support and wear resistance to maintain precise axial movement over a large number of cycles. Without being limited to a specific theory, such excellent performance is believed to be attributable at least in part to the fact that the force application on the thrust lug is substantially in the same plane as the opening in the guide plate opening supporting the guide shaft.

As will be appreciated, while the present invention has been illustrated and described in relation to various potentially preferred embodiments, constructions, and procedures, it is to be understood that such embodiments, constructions, and procedures are illustrative only and that the present invention is in no event to be limited thereto. Rather, it is contemplated that modifications and variations embodying the principles of the invention will no doubt occur to those of skill in the art to which the invention pertains. Therefore, it is contemplated and intended that the present invention shall extend to all such modifications and variations as may incorporate the broad principles of the invention within the full spirit and scope thereof.

1. An improved self returning floor mounted hinge assembly for a door, the hinge assembly having a base plate adapted to be mounted to a support floor; a bearing cam assembly secured in substantially fixed relation to the base plate, wherein the bearing cam assembly includes a pair of spaced apart roller elements; a frame structure adapted for mounting to the door in rotatable relation to the bearing cam assembly; a guide shaft having a first end projecting away from the bearing cam assembly, the first end being supported in sliding relation within an opening in the frame structure, the guide shaft having a second end projecting towards the bearing cam assembly said second end being operatively connected to a cam follower thrust lug having an angled face operatively engaging the roller elements; a coil compression spring disposed in surrounding relation to the guide shaft such that the guide shaft is slideable through the compression spring, the compression spring being disposed between the frame structure and a compression element operatively affixed at a position along the guide shaft such that upon axial movement of the guide shaft away from the bearing cam assembly, the coil spring is compressed in a region between the frame structure and the compression element, wherein the improvement comprises:
a guide plate affixed to the frame and having an opening substantially surrounding the guide shaft at a position between the compression element and the cam follower thrust lug such that the guide shaft is supported in sliding relation by the guide plate, the opening in the guide plate being substantially aligned with the opening in the frame structure supporting the first end of the guide shaft and wherein the hinge assembly is substantially free of guide pin elements moveable with the guide shaft and projecting through the frame in transverse relation to the guide shaft.

2. An improved self returning floor mounted hinge assembly for a door, the hinge assembly having a base plate adapted to be mounted to a support floor; a bearing cam assembly secured in substantially fixed relation to the base plate, wherein the bearing cam assembly includes a pair of spaced apart roller elements; a frame structure adapted for mounting to the door in rotatable relation to the bearing cam assembly; a guide shaft having a first end projecting away from the bearing cam assembly, the first end being supported in sliding relation within an opening in the frame structure, the guide shaft having a second end projecting towards the bearing cam assembly said second end being operatively connected to a cam follower thrust lug having an angled face operatively engaging the roller elements; a coil compression spring disposed in surrounding relation to the guide shaft such that the guide shaft is slideable through the compression spring, the compression spring being disposed between the frame structure and a compression element operatively affixed at a position along the guide shaft such that upon axial movement of the guide shaft away from the bearing cam assembly, the coil spring is compressed in a region between the frame structure and the compression element, wherein the improvement comprises:
a guide plate affixed to the frame and having an opening substantially surrounding the guide shaft at a position between the compression element and the cam follower thrust lug such that the guide shaft is supported in sliding relation by the guide plate, the opening in the guide plate being substantially aligned with the opening in the frame structure supporting the first end of the guide shaft, the guide plate having a substantially “H” shaped pattern including a pair of upwardly extending legs fitted within acceptance slots in a portion of the frame above the guide shaft and a pair of downwardly extending legs fitted within acceptance slots in a portion of the frame below the guide shaft and wherein the hinge assembly is substantially free of guide pin elements moveable with the guide shaft and projecting through the frame in transverse relation to the guide shaft.
